(19) United States
(12) Patent Application Publication
(10) Pub. No.: US 2026/0104558 A1
(43) Pub. Date: Apr. 16, 2026

(54) CONNECTOR ASSEMBLY

(71) Applicant: MD Elektronik GmbH, Waldkraiburg (DE)

(72) Inventors: Thomas Halbig, Dietfurt (DE); Stefan Fuchs, Ampfing (DE); Rudolf Engl, Ampfing (DE)

(21) Appl. No.: 19/336,571

(22) Filed: Sep. 23, 2025

(30) Foreign Application Priority Data
Oct. 10, 2024 (DE) 10 2024 129 240.7

(51) Int. Cl. G02B 6/38

(52) U.S. Cl. CPC G02B 6/3887; G02B 6/381

(57) ABSTRACT

A connector assembly includes a connector housing which, at a mating end, is connectable to a mating connector, a cable having at least one optical waveguide enclosed by a cable jacket, an attachment unit, and a contact unit having at least one contact end. The optical waveguide protrudes from the cable jacket at a cable end of the cable, and the contact unit is disposed within the connector housing. The optical waveguide extends through the contact unit to the contact end, where the optical waveguide is connected to the mating connector in a signal-conducting relationship therewith. The attachment unit encloses the cable jacket at the cable end, and the attachment unit is connected to the cable jacket by a material-to-material bond and/or by an interlocking connection. The attachment unit has at least one first latching element, which is connected to a first complementary latching element on the connector housing.

### CROSS REFERENCE TO RELATED APPLICATIONS

This application claims benefit to German Patent Application No. DE 102024129 240.7, filed on October 10, 2024, which is hereby incorporated by reference herein.

### FIELD

The invention relates to a connector assembly system for optical signal cables.

### BACKGROUND

Optical signal cables, such as fiber-optic cables, have been established in practice for decades for the transmission of large volumes of signals and data. In the wake of digitization and automation, and the associated increase in the required data volumes, optical signal cables are increasingly being used in areas where electrical signal cables have long been predominant. This is mainly due to the fact that the required transmission quantities are becoming increasingly difficult to provide using electrical signal cables. However, as the applications of optical signal cables expand into new fields, the requirements placed on the signal cables and the connector systems allowing connection of optical signal cables change as well. Consequently, there is an increasing need for economical connector systems for optical signal cables that are both resistant to environmental influences and resistant to mechanical stresses which may act on the pluggable connection during the mating process or in the mated condition.

In the case of cable-mounted connectors, it is in particular required that a reliable optical signal connection between the connector and a mating connector connected thereto is maintained, even when tensile forces are exerted on the connector or the cable.

### SUMMARY

In an embodiment, the present disclosure provides a connector assembly that includes a connector housing which, at a mating end, is connectable to a mating connector, a cable having at least one optical waveguide enclosed by a cable jacket, an attachment unit, and a contact unit having at least one contact end. The optical waveguide protrudes from the cable jacket at a cable end of the cable, and the contact unit is disposed within the connector housing. The optical waveguide extends through the contact unit to the contact end, where the optical waveguide is connected to the mating connector in a signal-conducting relationship therewith. The attachment unit encloses the cable jacket at the cable end, and the attachment unit is connected to the cable jacket by a material-to-material bond and/or by an interlocking connection. The attachment unit has at least one first latching element, which is connected to a first complementary latching element on the connector housing, so that the cable is secured to the connector housing. At least one spring element is disposed between the contact unit and the attachment unit, where the at least one spring element biases the contact unit in a direction of the mating end against an abutment surface of the connector housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a perspective exploded view of an embodiment of a connector assembly according to the present disclosure;

FIG. 2 is a perspective view of an embodiment of a cable end of the connector assembly according to the present disclosure;

FIG. 3 is a perspective view of an embodiment of a contact unit of the connector assembly according to the present disclosure;

FIG. 4 is a sectional view of an embodiment of the connector assembly according to the present disclosure; and

FIG. 5 is another sectional view of an embodiment of the connector assembly according to the present disclosure.

### DETAILED DESCRIPTION

Embodiments of the present disclosure provide a connector assembly that is resistant to mechanical loads acting thereon and ensures a reliable signal connection.

A connector assembly according to an embodiment of the present disclosure includes a connector housing, a cable, an attachment unit, and a contact unit. The connector housing has a mating end. At the mating end, the connector housing is connectable to a mating connector. The cable has at least one optical waveguide. The optical waveguide is enclosed by a cable jacket. However, the cable may also have a plurality of optical waveguides. In this case, the plurality of optical waveguides are enclosed together by the cable jacket. The optical waveguide protrudes from the cable jacket at an end of the cable. In other words, the optical waveguide is exposed. The contact unit has at least one contact end. The contact end is preferably parallel to the mating end. The contact unit is disposed within the connector housing. The optical waveguide extends through the contact unit to the contact end. Preferably, the optical waveguide is partially enclosed by the contact unit. At the contact end, the optical waveguide can be connected to the mating connector in signal-conducting relationship therewith. Therefore, the optical waveguide is preferably accessible via the contact end. If the cable has a plurality of optical waveguides, the plurality of optical waveguides may be disposed together at the contact end. In an embodiment of the present disclosure, the contact unit may have a plurality of contact ends, so that the plurality of optical waveguides extend to different contact ends. It is particularly preferred that each optical waveguide of the cable has associated therewith a contact end. Furthermore, the contact ends may be disposed in one plane. The optical waveguide may have a coating having one or more layers. For example, the optical waveguide may have one coating layer. Preferably, the coating is partially or completely removed over a length of the optical waveguide that is enclosed by the contact unit.

The attachment unit encloses the cable jacket at the cable end. The attachment unit is connected to the cable jacket by a material-to-material bond and/or by an interlocking connection. Preferably, the attachment unit is disposed within the connector housing. Moreover, the attachment unit has at least one first latching element, which is connected to at least one first complementary latching element on the connector housing. In this way, the cable is secured to the connector housing. At least one spring element is disposed between the contact unit and the attachment unit. The spring element biases the contact unit in the direction of the mating end against an abutment surface of the connector housing. Preferably, the spring element acts parallel to a mating axis.

A connector assembly according to an embodiment of the present disclosure provides a secure and robust connection between the optical waveguide and a mating connector that is plug-compatible with the connector assembly according to the present disclosure. Since the attachment unit is connected to the cable jacket and to the connector, tensile forces acting on the cable jacket can be transferred via the connector housing. Because the spring element biases the contact unit against the abutment surface, it is also ensured that the optical waveguide is always positioned in a defined manner together with the contact unit. Furthermore, after connection of the connector assembly to a mating connector, it is ensured that the contact unit, and thus the optical waveguide, is pressed against the mating connector by the spring element. This ensures a reliable, signal-conducting optical connection, even when the connector assembly is subjected to increased stresses, such as vibrations or shocks.

The attachment unit may take the form of an injection-molded component. The cable jacket may be connected to a plastic matrix of the attachment unit and/or embedded in the plastic matrix. The plastic matrix may be connected to the cable jacket by a material-to-material bond. In an embodiment of the present disclosure, an interlocking connection may be formed between the cable jacket and the attachment unit by the cable jacket being at least partially embedded in the plastic matrix. The interlocking connection may be formed, for example, by the plastic matrix being disposed in undercuts or recesses in the cable jacket.

The cable may have reinforcing fibers embedded in the plastic matrix of the attachment unit. The reinforcing fibers may be, for example, aramid fibers or polyester fibers. The reinforcing fibers preferably extend along the cable and may enclose the optical waveguide. The reinforcing fibers may be in the form of, for example, woven or knitted fabrics. Preferably, the reinforcing fibers are enclosed by the cable jacket. However, to enable embedding in the plastic matrix, it is preferred that the reinforcing fibers are exposed at the cable end.

The contact unit may have a second latching element, which may be connected to a second complementary latching element on the connector housing. The second latching element may be formed monolithically with the contact unit. This allows the contact unit to be easily mounted in the connector housing and retained in position. Nevertheless, it remains substantially mechanically decoupled from the attachment unit, since the contact unit is connected to the attachment unit only via the spring element.

The spring element may be formed monolithically with the contact unit. In this case, the spring effect of the spring element is preferably produced by the resilient characteristics of the material from which the contact unit or the spring element is formed. For example, the contact unit may be formed from a thermoplastic material. Thus, in addition to the shape of the spring element, the spring force of the spring element is essentially determined by the elastic properties of the selected thermoplastic material.

The contact unit may have a ferrule housing. The ferrule housing may be composed of two, in particular releasably, joinable housing parts. The housing parts may be connected to each other, for example, by simple latching or snap-fit connections. Furthermore, the contact unit may have at least one contact ferrule on which the contact end is located. The optical waveguide may extend through the contact ferrule to the contact end. Preferably, the contact ferrule is supported within the ferrule housing. The optical waveguide may be enclosed by the contact ferrule, it being preferred that coatings of the optical waveguide are partially or completely removed in the region that is enclosed by the contact ferrule. The optical waveguide may be connected to the contact ferrule by a material-to-material bond. It is also preferred that the contact ferrule protrudes from the ferrule housing parallel to the mating axis in the direction of the mating end. It is particularly preferred that the contact end is disposed outside the ferrule housing. If the cable has a plurality of optical waveguides, a contact ferrule may be provided for each optical waveguide. If the contact unit has a plurality of contact ferrules, these may be disposed parallel to each other.

The optical waveguide may be movable along the direction of its longitudinal extent relative to the cable jacket. In other words, the optical waveguide may be floatingly supported relative to the cable jacket. In this context, the direction of longitudinal extent can be understood to mean the direction of the longest extension of the optical waveguide. Because the optical waveguide is floatingly supported relative to the cable jacket, any tensile forces acting on the cable jacket are not transferred to the optical waveguide.

The cable may have a support ferrule, which may be disposed between the optical waveguide and the cable jacket. The support ferrule may be inserted into the cable jacket at the cable end, with the support ferrule enclosing the optical waveguide. The support ferrule is preferably made of a metal. The support ferrule may be partially enclosed by the attachment unit. Particularly preferably, the support ferrule is fixed in position on the cable end by the attachment unit. By means of the support ferrule, it can be ensured, for example, that the optical waveguide is not damaged when connecting the attachment unit to the cable jacket. If the attachment unit is formed by an injection-molded component, the support ferrule can also ensure that no plastic matrix reaches the optical waveguide.

The support ferrule may have an, in particular funnel-shaped, collar at an end opposite the cable jacket. The collar preferably extends away from the optical waveguide. By means of the collar, it can be ensured, for example, that the optical waveguide does not become damaged at the edge regions of the support ferrule.

The support ferrule may extend through an access opening into a receiving chamber of the contact unit. The collar may be disposed in the receiving chamber. The access opening may have an inner diameter that is smaller than the outer diameter of the collar. Thus, the contact unit is positioned in a defined manner on the attachment unit. This allows the contact unit and the attachment unit to be mounted together in the connector housing.

The collar may be movable within the receiving chamber along and in particular parallel to the mating axis. If the contact unit is biased against the abutment surface, the collar or the support ferrule may preferably be movable away from the mating end. This may be achieved, for example, by the receiving chamber being configured such that the collar has sufficient free space for movement along the mating axis in order to be moved along the mating axis. This ensures that the contact unit remains mechanically decoupled from the cable jacket and from the attachment unit. In particular, this prevents tensile forces acting on the cable jacket from being transferred to the contact unit.

The connector assembly according to an embodiment of the present disclosure may have a secondary locking element. The secondary locking element may be movable between a pre-latched position and a final latched position, In the final latched position, the secondary locking element can connect the attachment unit to the connector housing. In this context, this can be understood to mean that the secondary locking element secures the attachment unit to the connector housing in the final latched position. Such securement is accomplished independently of the attachment via the first latching element and the first complementary latching element. In an embodiment of the present disclosure, the secondary locking element can lock the first complementary latching element in place, thereby preventing release of the connection between the first latching element and the first complementary latching element. In the pre-latched position, the secondary locking element can release the attachment unit relative to the connector housing. In an embodiment of the present disclosure, in the pre-latched position, the secondary locking element may enable release of the connection between the first latching element and the first complementary latching element. Preferably, the secondary locking element is movable between the pre-latched position and a final latched position along a movement axis perpendicular to the mating axis.

The connector housing may have at least one connecting channel between the mating end and the abutment surface, in which the contact end may be disposed. For this purpose, the contact unit may be partially disposed within the connecting channel. If the contact unit has a contact ferrule, the contact ferrule may also be partially disposed within the connecting channel. The connecting channel preferably extends parallel to the mating axis. Furthermore, it is preferred that a mating connector can be inserted into the connecting channel via the mating end, and that, at the contact end, the optical waveguide can be connected to the mating connector in signal-conducting relationship therewith. This provides the advantage that the connector assembly according to an embodiment of the present disclosure can be configured as a female connector, and thus facilitates the positioning of a male mating connector.

The connecting channel may have disposed therein a guide tube which encloses the contact ferrule along a portion thereof. If the contact unit has a contact ferrule, the contact ferrule may at least partially be disposed within the guide tube. The guide tube is preferably made of a metal or a ceramic. The guide tube allows for more precise positioning of the contact unit with a mating connector relative to each other.

The guide tube may rest against the contact ferrules with an end facing the contact ferrules. The guide tube preferably has a length no greater than the sum of the lengths of the portion of the contact unit and of the portion of the mating connector that are disposed in the guide tube when the connector assembly is connected to the mating connector. Particularly preferably, the guide tube is shorter than the sum of the lengths of the portion of the contact unit and of the portion of the mating connector that are disposed in the guide tube when the connector assembly is connected to the mating connector. Because the guide tube rests against the contact ferrules, the guide tube can be used as a reference to position the contact unit at the desired distance relative to the mating connector.

In addition, further advantages and features of the present disclosure will be apparent from the following description of exemplary embodiments. The features described therein and hereinabove may be implemented alone or in combination, unless they contradict each other. The following description of the exemplary embodiments is made with reference to the accompanying drawings.

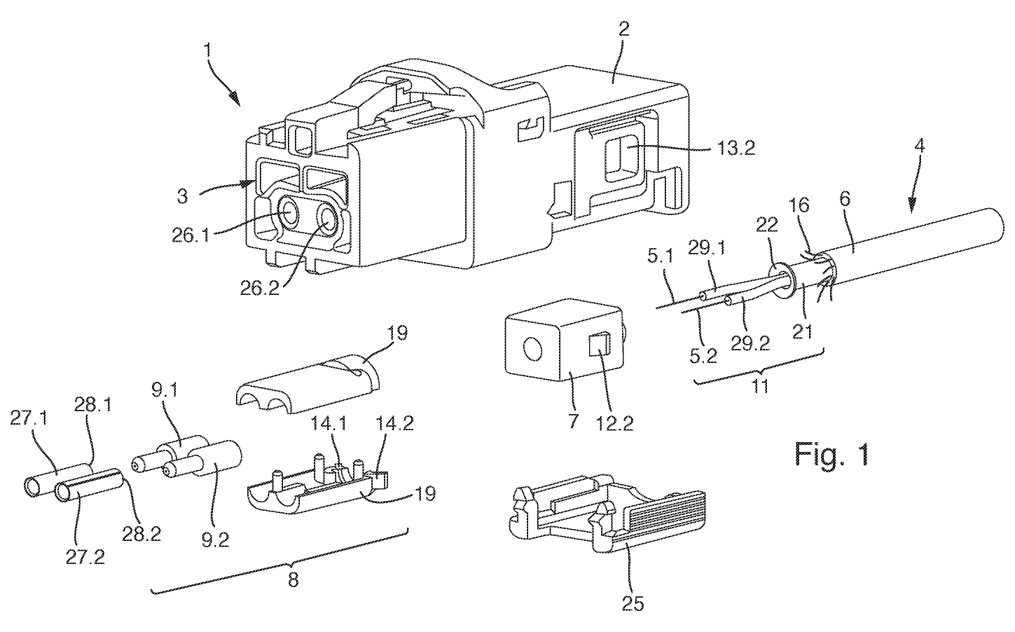

FIG. 1 shows an embodiment of an exemplary connector assembly 1 in a perspective exploded view. Connector assembly 1 has a connector housing 2. At a mating end 3, connector housing 2 can be connected to a mating connector in signal-conducting relationship therewith. Connector assembly 1 further includes a cable 4. Cable 4 includes two optical waveguides 5.1; 5.2 enclosed by a cable jacket 6. Optical waveguides 5.1; 5.2 have a multi-layer coating 29.1; 29.2, which is removed over a certain length. Cable 4 further includes reinforcing fibers 16 in the form of aramid fibers. Reinforcing fibers 16 also enclose optical waveguides 5.1; 5.2. Optical waveguides 5.1; 5.2 protrude from cable jacket 6 at a cable end 11. In the present embodiment, this is achieved by removing cable jacket 6. A support ferrule 21 is inserted into cable jacket 6 at cable end 11, with optical waveguides 5.1; 5.2 extending through support ferrule 21. Furthermore, support ferrule 21 is disposed between optical waveguides 5.1; 5.5.2 and reinforcing fibers 16.

The exemplary connector assembly 1 has an attachment unit 7. Attachment unit 7 is formed from a thermoplastic material and encloses cable jacket 6 at cable end 11. Attachment unit 7 is connected to cable jacket 6 by a material-to-material bond and an interlocking connection. Furthermore, reinforcing fibers 16 are embedded in a plastic matrix of attachment unit 7. Attachment unit 7 also encloses support ferrule 21. Consequently, attachment unit 7 holds support ferrule 21 in position relative to cable jacket 6. Attachment unit 7 is disposed within connector housing 2. Attachment unit 7 has first latching elements 12.2, which are connected to first complementary latching elements 13.2 of the connector housing. In this way, attachment unit 7 is secured to connector housing 2. Support ferrule 21 and optical waveguides 5.1; 5.2 extend through attachment unit 7. Optical waveguides 5.1; 5.2 are movable relative to cable jacket 6 and support ferrule 21 along the direction of their longitudinal extent.

The exemplary connector assembly 1 also has a contact unit 8. In the present embodiment, contact unit 8 has a ferrule housing 19 composed of two housing halves. The housing halves can be releasably joined together. Ferrule housing 19 has two spring elements 14.1; 14.2 formed monolithically with ferrule housing 20. Spring elements 14.1; 14.2 extend toward attachment unit 7. Contact unit 8 further has two contact ferrules 9.1; 9.2. Contact ferrules 9.1; 9.2 are partially supported within ferrule housing 19. Optical waveguides 5.1; 5.2 extend through contact unit 8 and are each led to a respective one of contact ferrules 9.1; 9.2. Optical waveguides 5.1; 5.2 are enclosed by contact ferrules 9.1; 9.2 over the length where the coating 29.1; 29.2 is removed. Furthermore, optical waveguides 5.1; 5.2 are non-releasably connected to contact ferrules 9.1; 9.2. Contact ferrules 9.1; 9.2 protrude from contact unit 8 over a certain length and are each partially disposed in a guide tube 27.1; 27.2. Guide tubes 27.1; 27.2 are each disposed in a connecting channel 26.1; 26.2 of connector housing 2. Moreover, guide tubes 27.1; 27.2 rest against the respective contact ferrules 9.1; 9.2 at their ends 28.1; 28.2 facing the contact ferrules 9.1; 9.2. Connector assembly 1 has a secondary locking element 25 that is movable between a pre-latched position and a final latched position.

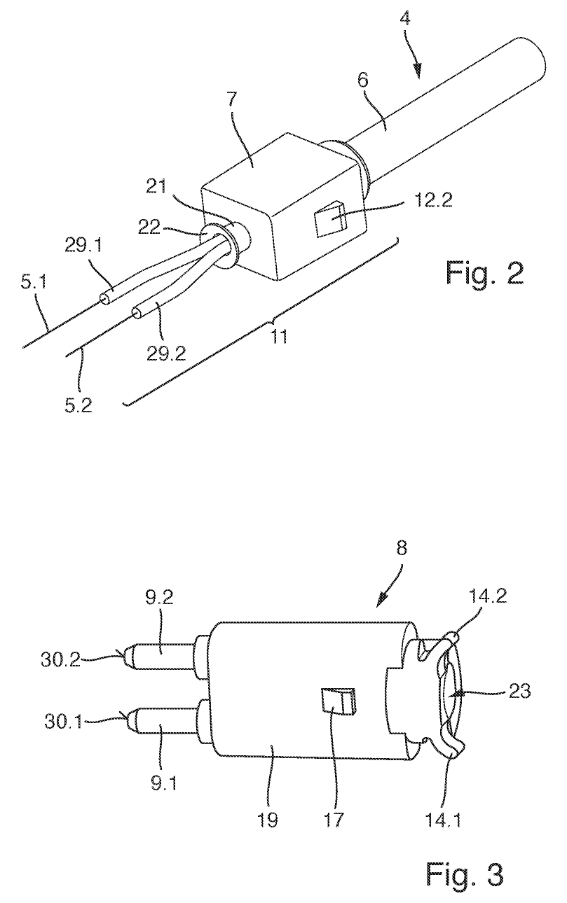

FIG. 2 shows a perspective view of an embodiment of cable 4 of the exemplary connector assembly 1 in the region of cable end 11. Attachment unit 7 encloses cable jacket 6 and is connected thereto by a material-to-material bond and an interlocking connection. Furthermore, attachment unit 7 partially encloses support ferrule 21. Support ferrule 21 is formed of metal. In order to prevent optical waveguide 5.1; 5.2 and coating 29.1; 29.2 from being damaged by support ferrule 21, support ferrule 21 has a funnel-shaped collar 22 that extends away from optical waveguides 5.1; 5.2.

FIG. 3 shows a perspective view of an embodiment of contact unit 8 of the exemplary connector assembly 1. Contact unit 8 has an access opening 23 via which the optical waveguides are led to contact ferrules 9.1; 9.2. Furthermore, a second latching element 17 is disposed on ferrule housing 19. Ferrule housing 19 has two spring elements 14.1; 14.2 at the end where access opening 23 is located. The two contact ferrules 9.1; 9.2 form a contact end 30.1; 30.2 at an end located outside ferrule housing 19.

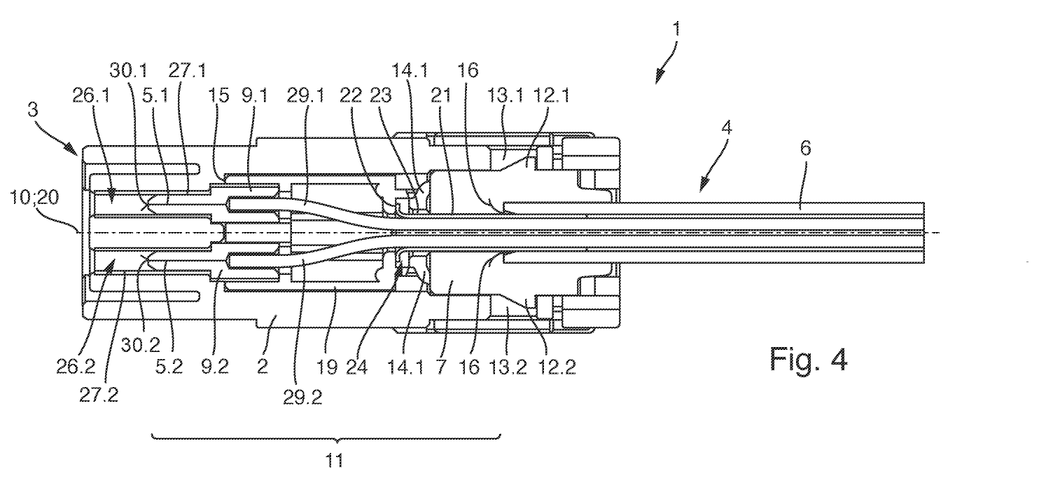

FIG. 4 shows a sectional view of the embodiment of the exemplary connector assembly 1 of FIG. 1. The sectional plane passes through a mating axis 20 and through contact ferrules 9.1; 9.2. Both attachment unit 7 and contact unit 8 are inserted into connector housing 2 via a rear end opposite mating end 3. Spring elements 14.1; 14.2 rest against attachment unit 7, biasing contact unit 8 against an abutment surface 15. In the present embodiment, abutment surface 15 is parallel to mating end 3. Thus, contact unit 8, and thus also the optical waveguides 5.1; 5.2 connected to contact ferrules 9.1; 9.2, is held at a defined position. Guide tubes 27.1; 27.2 are disposed in connecting channels 26.1; 2. Connecting channels 26.1; 26.2 extend from abutment surface 15 to mating end 3. Each of guide tubes 27.1; 27.2 has a contact ferrule 9.1; 9.2 partially disposed therein. Consequently, contact ends 30.1; 30.2 of both contact ferrules 9.1; 9.2 are disposed within the respective guide tubes 27.1, 27.2. Optical waveguides 5.1, 5.2 extend through contact ferrules 9.1; 9.2 up to contact ends 30.1, 30.2. Because attachment unit 7 is connected via first latching elements 12.1; 12.2 to first complementary latching elements 13.1; 13.2, tensile forces acting on cable jacket 6 are transferred to connector housing 2. Since optical waveguides 5.1; 5.2 are movable relative to support ferrule 21 and cable jacket 6 along the direction of their longitudinal extent, the risk of tensile forces being transmitted from cable jacket 6 to optical waveguides 5.1; 5.2 is particularly low.

Contact unit 8 has a receiving chamber 24, in which collar 22 of support ferrule 21 is disposed. Support ferrule 21 is passed through access opening 23. Access opening 23 has an inner diameter that is smaller than the outer diameter of collar 22. Receiving chamber 24 is configured such that collar 22 is movable along mating axis 20 and away from mating end 3, without collar 22 striking a wall of contact unit 8. This ensures that contact unit 8 remains mechanically decoupled from attachment element 7 even when tensile forces acting on cable jacket 6 are so great that they cause support ferrule 21, and thus collar 22, to move away from mating end 3. Thus, mechanical coupling between contact unit 8 and attachment unit 7 does not occur until collar 22 reaches access opening 23.

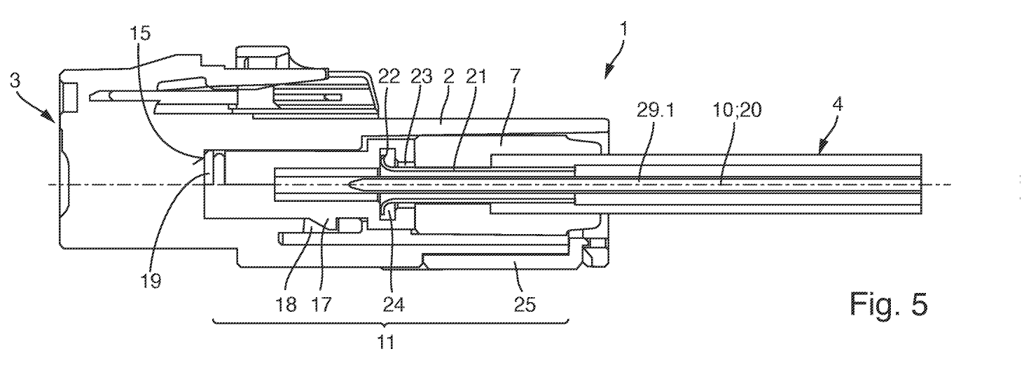

FIG. 5 shows another sectional view of the embodiment of the exemplary connector assembly 1 of FIG. 1. The sectional plane is parallel to mating axis 19 and perpendicular to a plane defined by contact ferrules 9.1; 9.2. Ferrule housing 19 has a second latching element 17. Connector housing 2 has a second complementary latching element 18 connected to second latching element 17. Consequently, contact unit 8 is connected to connector housing 2 independently of attachment unit 7. In the present view, secondary locking element 25 is in the final latched position. In the present embodiment, secondary locking element 25 connects attachment unit 7 to connector housing 2 by blocking movement of attachment unit 7 away from mating end 3. Furthermore, secondary locking element 25 inhibits release of the connection between first latching element 12 and the first complementary latching element 13.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 connector assembly

2 connector housing

3 mating end

4 cable

5 optical waveguide

6 cable jacket

7 attachment unit

8 contact unit

9 contact ferrule

10 direction of longitudinal extent (optical waveguide)

11 cable end

12 first latching element

13 first complementary latching element

14 spring element

15 abutment surface

16 reinforcing fibers

17 second latching element

18 second complementary latching element

19 ferrule housing

20 mating axis

21 support ferrule

22 collar

23 access opening

24 receiving chamber

25 secondary locking element

26 connecting channel

27 guide tube

28 end of the guide tube facing the contact unit

29 coating

30 contact end

1. A connector assembly comprising:
a connector housing which, at a mating end, is connectable to a mating connector;
a cable having at least one optical waveguide enclosed by a cable jacket;
an attachment unit; and
a contact unit having at least one contact end;
wherein
the optical waveguide protrudes from the cable jacket at a cable end of the cable,
the contact unit is disposed within the connector housing,
the optical waveguide extends through the contact unit to the contact end, wherein the optical waveguide is connected to the mating connector in a signal-conducting relationship therewith,
the attachment unit encloses the cable jacket at the cable end,
the attachment unit is connected to the cable jacket by a material-to-material bond and/or by an interlocking connection,
the attachment unit has at least one first latching element, which is connected to a first complementary latching element on the connector housing, so that the cable is secured to the connector housing, and
at least one spring element is disposed between the contact unit and the attachment unit, the at least one spring element biasing the contact unit in a direction of the mating end against an abutment surface of the connector housing.

2. The connector assembly as recited in claim 1, wherein the attachment unit takes the form of an injection-molded component, and the cable jacket is connected to a plastic matrix of the attachment unit and/or embedded in the plastic matrix.

3. The connector assembly as recited in claim 2, wherein the cable has reinforcing fibers embedded in the plastic matrix of the attachment unit.

4. The connector assembly as recited in claim 1, wherein the contact unit has a second latching element, which is connected to a second complementary latching element on the connector housing.

5. The connector assembly as recited in claim 1, wherein the spring element is formed monolithically with the contact unit.

6. The connector assembly as recited in claim 1, wherein the contact unit has a ferrule housing and at least one contact ferrule, the contact ferrule being supported in the ferrule housing, and the contact end is located on the contact ferrule.

7. The connector assembly as recited in claim 1, wherein the optical waveguide is movable along a direction of its longitudinal extent relative to the cable jacket.

8. The connector assembly as recited in claim 1, wherein the cable has a support ferrule at the cable end, the support ferrule being disposed between the optical waveguide and the cable jacket.

9. The connector assembly as recited in claim 8, wherein the support ferrule has a collar at an end opposite the cable jacket.

10. The connector assembly as recited in claim 9, wherein the support ferrule extends through an access opening into a receiving chamber of the contact unit, the collar is disposed in the receiving chamber, and the access opening has an inner diameter that is smaller than an outer diameter of the collar.

11. The connector assembly as recited in claim 10, wherein the collar is movable within the receiving chamber along a mating axis.

12. The connector assembly as recited in claim 1, having a secondary locking element that is movable between a final latched position and a pre-latched position, wherein in the final latched position, the secondary locking element secures the attachment unit to the connector housing and/or inhibits release of the connection between the first latching element and the first complementary latching element, and, in the pre-latched position, the secondary locking element releases the attachment unit relative to the connector housing and/or enables release of the connection between the first latching element and the first complementary latching element.

13. The connector assembly as recited in claim 1, wherein the connector housing has at least one connecting channel between the mating end and the abutment surface, in which the contact end is disposed.

14. The connector assembly as recited in claim 6, wherein the connecting channel has disposed therein a guide tube which encloses the contact ferrule along a portion thereof.

15. The connector assembly as recited in claim 14, wherein the guide tube rests against the contact ferrule at an end facing the contact ferrule.

16. The connector assembly as recited in claim 9, wherein the support ferrule has a funnel-shaped collar at the end opposite the cable jacket.
